(19) United States
(12) Patent Application Publication
(10) Pub. No.: US 2006/0225558 A1
(43) Pub. Date: Oct. 12, 2006

(54) Clave one

(76) Inventor: Arthur John Bott, Alpine, CA (US)

Correspondence Address: CHARLES C. LOGAN II, 8282 UNIVERSITY AVENUE, La Mesa, CA, 91941, US

(21) Appl. No.: 11/011,969

(22) Filed: Mar. 29, 2005

(51) Int. Cl. G10D 13/08

(52) U.S. Cl. 84/403

(57) ABSTRACT

A percussion musical instrumcnt that has two elongated cylindrical pieces of wood connected together adjacent one of their adjacent ends with a hinge type structure. A spring normally keeps the distal ends of the cylindrical pieces of wood separated. The musical instrument can be held in one hand and a clicking sound is produced by repeatedly squeezing end of the cylindrical pieces of wood together.

### BACKGROUND OF THE CLAVE

In the traditional Genre, the CLAVE (which consists of (2) lathe-machined round rosewood/wood shafts that are approximately 8″ in length, and 1″ in diameter) have been in existence and used by professional Latin music artists for over 50 years. The Clave and it's sister family of percussion instruments, i.e. the Cow Bell, Maraca, Tambourine, and Gourd have always been considered the Latin percussionist's primary instruments of choice. Within the scope of traditional use, the mechanical functioning of the Clave demanded that the musician utilize (both) hands; thereby placing one Clave in each hand, and striking both Clave shafts together to execute its tradition performance characteristics, and to produce the distinct tonal quality of the Clave musical instrument.

In the world of Latin music, and the production/manufacture of Latin Percussion Instruments, there is currently no instrument in existence that can be compared to CLAVE ONE. Unique in design/utility application, let it now be known that there is ONLY ONE . . . CLAVE ONE!

### SUMMARY OF THE INVENTION

The most distinguishing characteristics of CLAVE ONE are as follows:

1. Design/Utility Functioning, which for the (first) time in over 50 years of known Clave existence, the Latin percussion artist will have the unique capability to execute the mechanical performance of the Clave Instrument by using only-one-hand, which traditionally requires that the Latin artist use (both) hands to execute the musical performance of the Clave. This feature design of CLAVE ONE is an invaluable asset for the professional Latin percussionist, which for the most part (only) a professional percussionist can fully appreciate the inherent virtues of the CLAVE ONE design and it's mechanical operation.

### BRIEF DESCRIPTION OF THE DRAWING

Sheet 1. Consists of (4) views showing my new design for CLAVE ONE.

FIG. 1 is a front view;

FIG. 2 is a plan view;

FIG. 3 is a side view (L);

FIG. 4 is an isometric view;

Sheet 2. FIG. 5 is a front view with dimensions;

FIG. 6 is a plan view with dimensions;

FIG. 7 is a side view (R) with dimensions;

FIG. 8 is an isometric view;

Sheet 3. FIG. 9 is a front view with dimensions;

FIG. 10 is a plan view with dimensions;

FIG. 11 is a side view (L) with dimensions;

FIG. 12 is an isometric view;

Sheet 4. FIG. 13 is a front view with dimensions;

FIG. 14 is a plan view with dimensions;

FIG. 15 is a side view (L) with dimensions;

FIG. 16 is an isometric view;

Sheet 5. FIGS. 17-20 is CLAVE ONE in motion (open to close position)

Sheet 6. FIG. 21 is CLAVE ONE exploded view (isometric); and

FIG. 22 is CLAVE ONE exploded view.

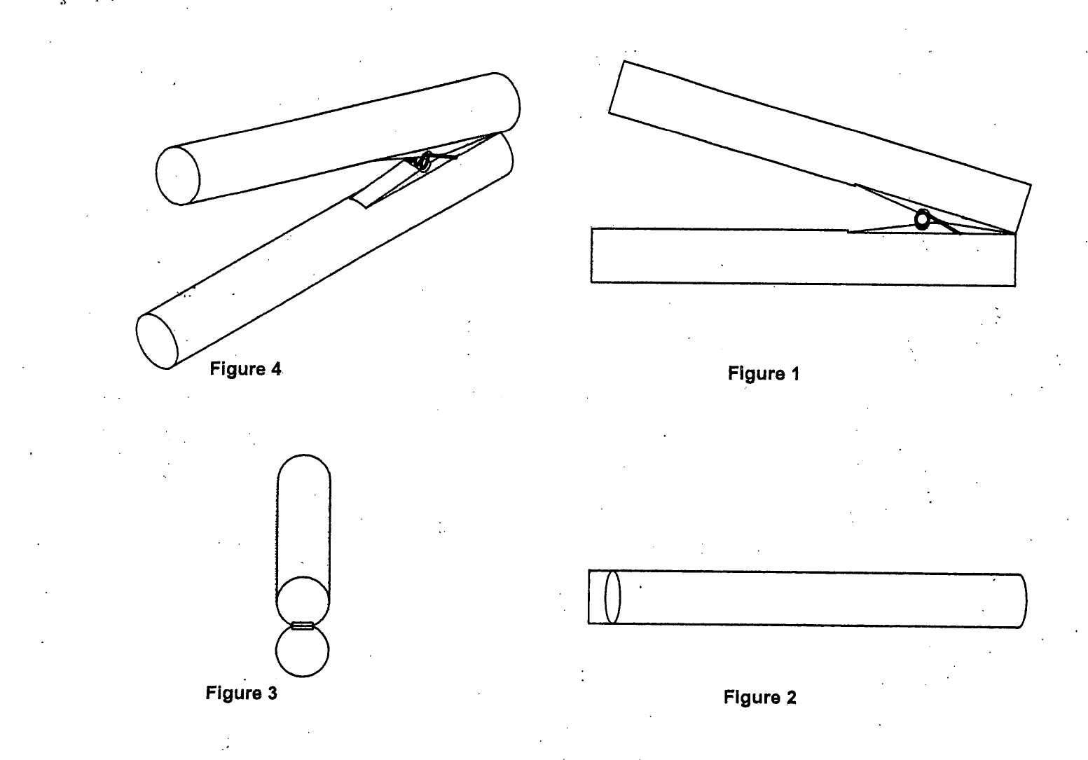

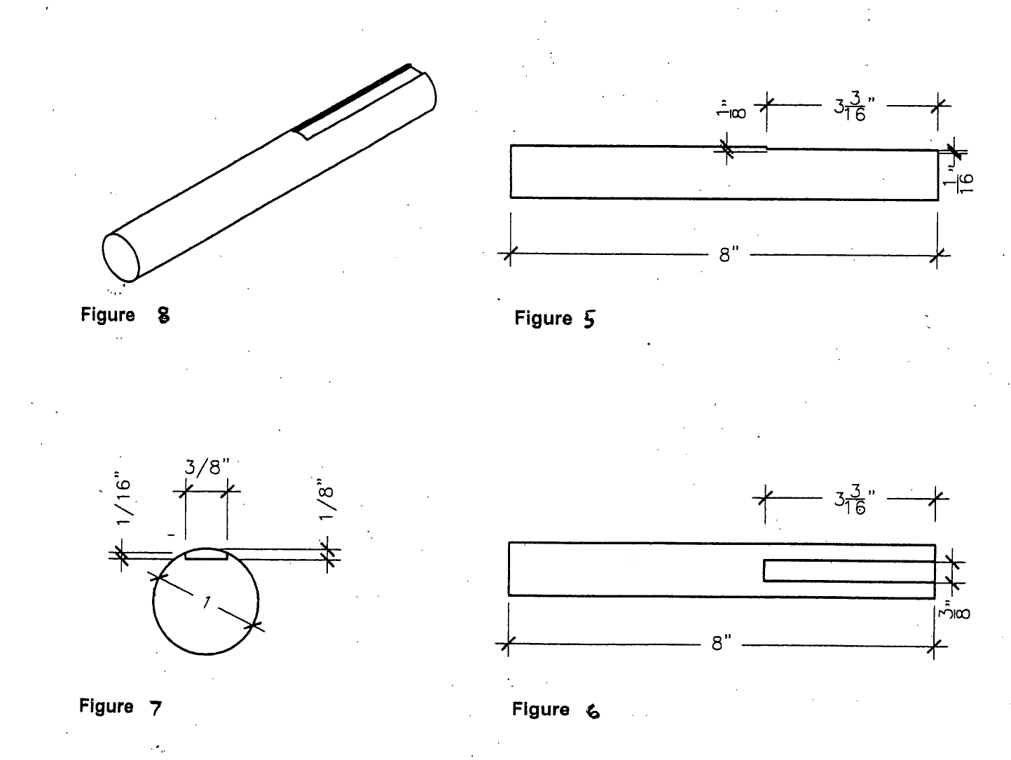

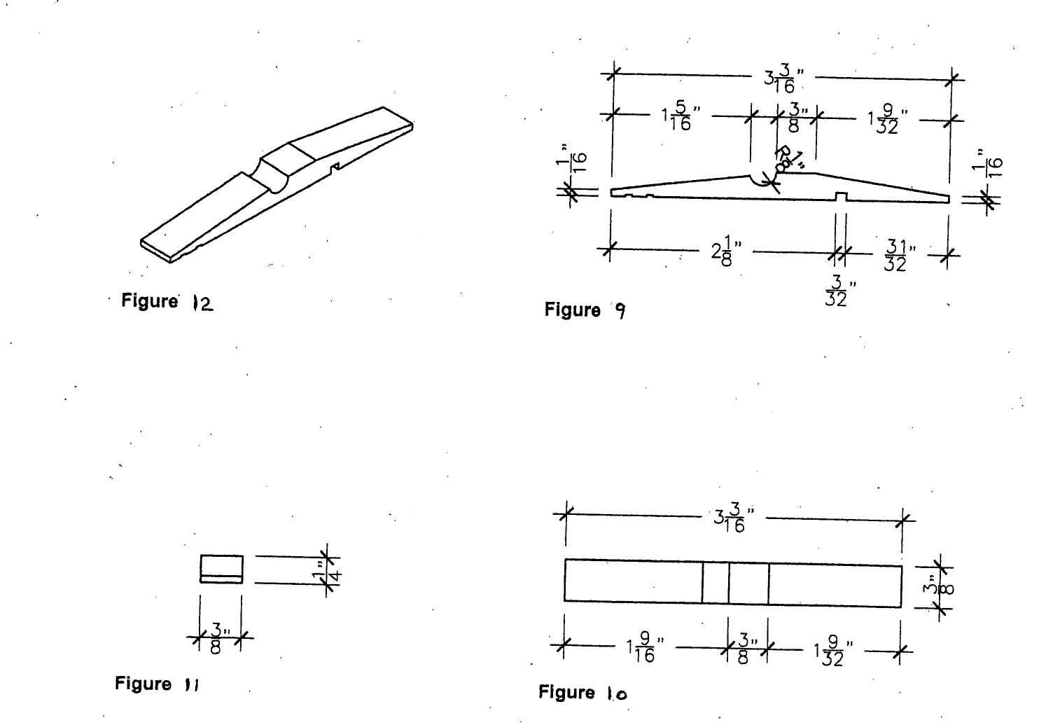

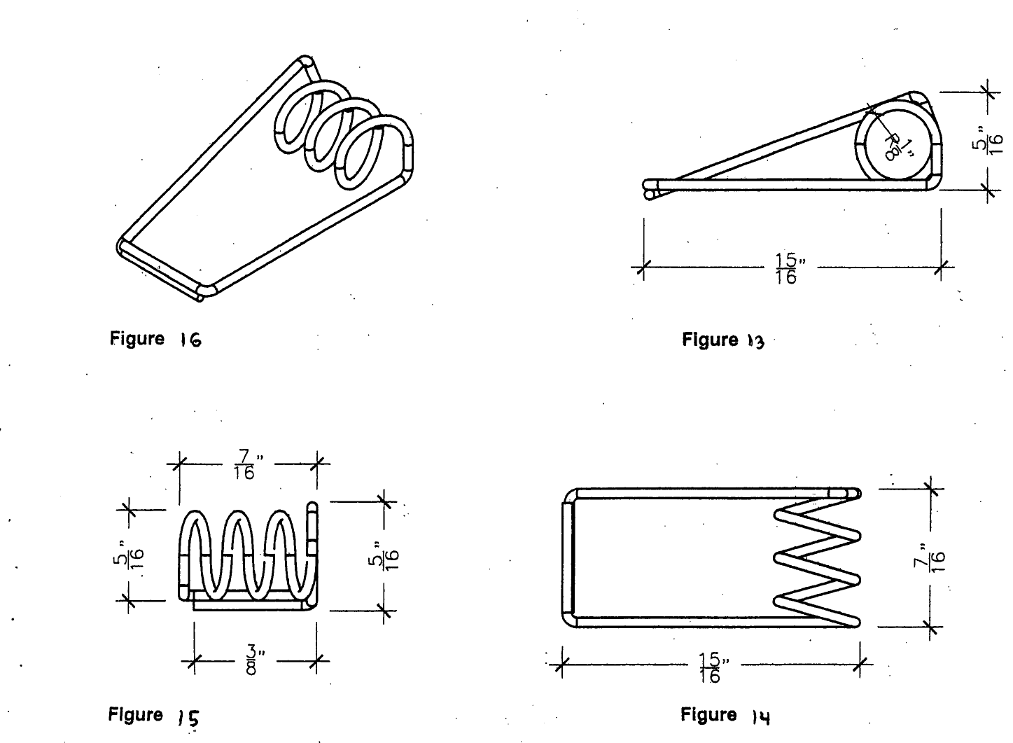

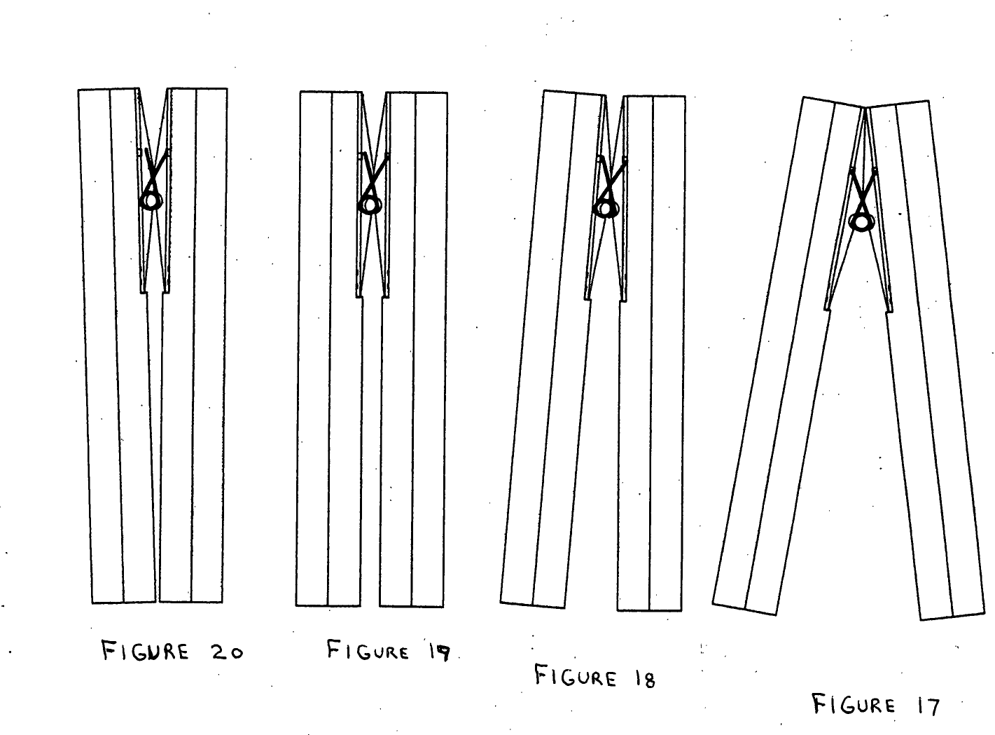

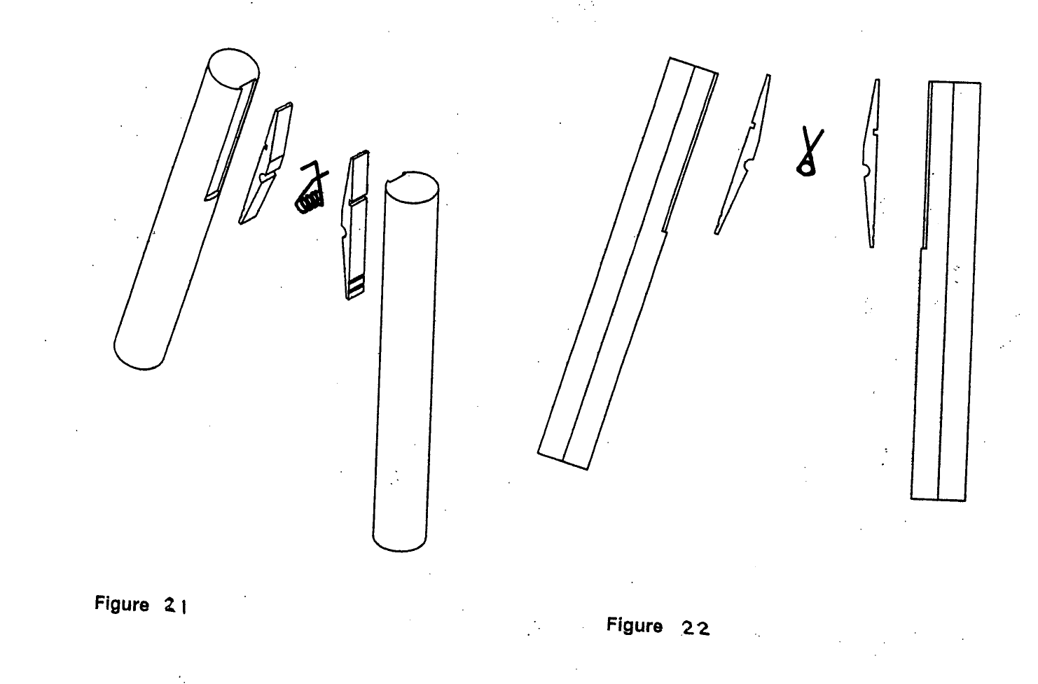

### DESCRIPTION OF THE PREFERRED EMBODIMENT

Design and Appearance

CLAVE ONE consists of (4) individual and dimensionally designed material parts:

1. Two lathe-machined pieces of rounded in shape Rosewood/Wood shafts, cut approximately to 8″ in length, and machined to approximately 1″ in diameter. Also, a dimensional-groove has been machined in one end of the Clave shaft, to facilitate the operational design/utility application of the named invention. (Refer to technical drawings, pages 1 thru 6).

2. Two dimensionally-designed pieces of pine wood material, cut and shaped to the size of 3 and 13/16″ in length, and ⅜″ in width, with various grooves shaped in the designed material to facilitate the operation design/utility application of the named invention. (refer to technical drawings pages 1 thru 6)

3. One dimensionally-designed stainless steel spring 15/16″ in length, and ⅜″ in width, coiled/shaped to a specific design to facilitate the operational design/utility application of the named invention. (refer to technical drawings, pages 1 thru 6)

The (4) material designed elements of CLAVE ONE are assembled in such a manner that BOTH CLAVES are co-enjoined together at one end of the clave wood shaft, thereby creating the letter “A” in constructed design, form, shape, and appearance of the named invention.

Design and Utility Performance

The operational design of CLAVE ONE facilitates the instrument to be held in ONE HAND, with one clave shaft resting in the open palm of the hand, with the end of the clave shaft extending thru the U portion of the palm area located between the thumb and index finger, and the other attached clave shaft resting on the inner (4) finger portion of the hand in such a manner that the movement (a closing of the hand motion) with the fingers resting on the clave shaft produces the “simultaneous closure” of (both) clave shafts in a “striking-motion” that creates a “clicking sound, the unique characteristic of the clave.

CLAVE ONE Tonal Characteristics

CLAVE ONE, (because of its design/utility application) has the unique dual-capability to produce (2) separate and distinct tonal characteristics. One of which (if so desired) produces the traditional “click sound” as distinguished by the character of the instrument. And the other (if so desired) produces a “vibrated-click” simulating multiple strokes with a one-strike-execution. Because of these unique features, CLAVE ONE is well suited to be considered a candidate for a revolutionary musical percussion instrument.

Multiple Strike Power Capability

CLAVE ONE, (bcaus of its dcsign/utility application) can bc utilized for pcrformancc in its exciting Dual-mode-stage. Which consists of the artiest holding (2) CLAVE ONE devices, onc in cach hand, and playing thcm simultaneously in rapid-firc succession, thus crcating an awesomely one-of-a-kind percussion clave explosion (unparalleled) in uniqueness, sound, and form.

1. A percussion musical instrument comprising:
two clongatcd cylindrical wooden shafts cach having a proximate end and a distal cnd; wooden shafts each having a length L1 and a diameter D1; and
hinge mcans connecting said proximate ends of said wooden shafts together;
said hinge means having a spring structure that keeps said distal ends of said wooden shafts separated in their static state; when said distal ends of said wooden shafts arc rapidly forced together in a striking motion to produce a clicking sound.

2. A percussion instrument as recited in claim 1 wherein L1 is substantially equal to 8 inches.

3. A percussion instrument as recited in claim 2 wherein D1 is substantially equal to 1 inch.

4. A percussion instrument as rccited in claim 1 whcrcin facing surfaces of said proximate ends of said wooden shafts have grooves formed therein for receiving said hinge mcans.

5. A percussion instrument as recited in claim 1 wherein said wooden shafts are made of Rosewood.
